(19) United States
(12) Patent Application Publication
(10) Pub. No.: US 2007/0168453 A1
(43) Pub. Date: Jul. 19, 2007

(54) Function managing apparatus

(76) Inventors: Atsushi Ito, Osaka (JP); Toshiro Nishio, Osaka (JP); Ryota Tsukidate, Kanagawa (JP); Yasuo Endo, Chiba (JP); Naoya Takao, Hyogo (JP); Yoshiaki Iwata, Osaka (JP); Masahiro Oashi, Kyoto (JP)

Correspondence Address: WENDEROTH, LIND & PONACK L.L.P., 2033 K. STREET, NW, SUITE 800, WASHINGTON, DC, 20006, US

(21) Appl. No.: 10/587,487

(22) PCT Filed: Jun. 21, 2005
(86) PCT No.: PCT/JP05/11302

§ 371 Date: Jul. 27, 2006

(30) Foreign Application Priority Data
Jun. 24, 2004 (JP) 2004-186070

(51) Int. Cl. G06F 15/167

(52) U.S. Cl. 709/213

(57) ABSTRACT

A function managing apparatus allows a user to avoid a fault likely to occur in a user terminal before a new function is installed on the user terminal. A function managing apparatus for communicating with a user terminal is provided. Specifically, the function managing apparatus includes a receiving unit, predicting unit, and alerting unit. The receiving unit receives from the user terminal the new function ID identifying the new function to be installed on the user terminal, and the installed function IDs identifying one or more functions previously installed on the user terminal. The predicting unit specifies the new function and one or more installed functions based on the new function ID and installed function IDs received by the receiving unit, and predicts the result when the new function is installed on the user terminal. The alerting unit notifies the user terminal of the prediction result of the predicting unit.

### FIELD OF THE INVENTION

The present invention relates to a function managing apparatus for performing security management of a terminal in which new functions are being installed.

### BACKGROUND

Capacity expansion and CPU performance increases in PCs and home servers and the like have advanced rapidly in recent years. Users can add software and hardware functions to the terminal as desired. For example, when installing software on the PC, the user inserts media on which the software is recorded into a CD-ROM drive, DVD drive or the like of the PC, and install screen appears on the PC and the software is then installed on the PC. Furthermore, the user may also access a search engine on the Web using a PC connected to the Internet to retrieve software, and download desired software from the a Web page and install it on the PC.

When software and hardware are installed on a terminal that has diverse software and hardware already installed, an unexpected functional fault may occur, such as the terminal will not start up and the like. The main source of such problems is a lack of compatibility in between combination of the software and hardware already installed on the terminal and the software and hardware newly installed on the terminal.

Since the software and hardware are installed on the terminal according to the preferences of the user, the structures of the installed software and hardware are different for each individual terminal. Therefore, when functional faults occur in terminals, the cause of the fault, such as incompatibility between the newly installed software and hardware and the previously installed software and hardware, will be different for each terminal.

Patent Document 1 discloses a system quickly pursuing and eliminating the cause of a fault when a function fault occurs in a product. In the system of Patent Document 1, the product stores a history of repair and modification as historical information. When new software or hardware installed in a product causes a fault, the repair technician connects a terminal to the product, and reads the historical information within the product. The repair technician determines what component changes the product has had based on the historical information read from the terminal, and repairs and modifies the product.

Patent Document 1: Japanese Laid-Open Patent Publication No. 2002-324143

### DISCLOSURE OF THE INVENTION

The system of Patent Document 1, however, performs countermeasures for faults that occur in the product, but cannot predict the likelihood of an occurrence of a fault in the product. Accordingly, in the system of Patent Document 1, faults that are likely to occur in the product cannot be avoided.

Faults caused as a result of installing new software and hardware on a terminal may also be intensified such as when the terminal can not start up.

An object of the present invention is to provide a function managing apparatus capable of knowing the likelihood of the occurrence of a fault in a terminal before a user installs a function, such as new software and hardware or the like, on a terminal, and avoiding the occurrence of a fault of the terminal.

To eliminate these problems, a first aspect of the invention provides a function managing apparatus that communicates with a user terminal. Specifically, the function managing apparatus is provided with a receiving unit, predicting unit, and alerting unit. The receiving unit receives from the user terminal new function identifiers that identify new function to be installed on the user terminal, and installed function identifiers that identify one or more functions already installed on the user terminal. The predicting unit specifies the new function and the one or more installed functions based on the new function identifier and installed function identifiers received by the receiving unit, and predicts the results of the new function being installed on the user terminal. The alerting unit notifies the user terminal of the prediction results of the predicting unit.

The prediction result may be, for example, information indicating whether or not the new function to be installed on the user terminal can be installed normally on the user terminal. The function managing apparatus predicts whether or not a new function can be installed normally based on the functions already installed on the user terminal before the function, such as new software and hardware and the like, is added to the user terminal, and notifies the user terminal of the prediction result. Therefore, the user can know whether or not a new function can be installed normally on a user terminal before the new function is installed. Thus, when, for example, there is concern that the installation of a new function on a user terminal will result in a fault on the user terminal, the user is notified of this concern before the new function is installed, and can devise means such as canceling the installation, installing a different alternative function and the like.

A second aspect of the invention further provides, in the first aspect, a memory unit configured to combine a plurality of function identifiers that specify a plurality of functions, and associate and store the results when any function among the plurality of functions has been successfully installed a user terminal on which another functions have been previously installed. Thus providing a function managing apparatus in which the predicting unit searches the memory unit using the combination of new function identifiers and one or more installed function identifiers as keys, and predicts the result when the new function will be successfully installed based on the search result.

The function managing apparatus is capable of predicting whether or not the new function to be installed on the user terminal can be installed normally based on a proprietary DB.

A third aspect of the invention provides, in the second aspect, a function managing apparatus in which the memory unit stores as a prediction result data indicating whether or not any function among the plurality of functions will be successfully installed in a user terminal on which another functions are already installed, and the predicting unit sets as prediction result data indicating whether a function will be successfully installed that is stored in search result hit entries.

The function managing apparatus notifies the user terminal whether or not the new function to be installed in the user terminal will generate a fault in the user terminal. Therefore, the user terminal can be notified whether or not a new function to be installed is safe for that terminal before installing the new function.

A fourth aspect of the invention provides, in the second aspect, a function managing apparatus in which the predicting unit determines that a prediction result is unclear when the memory unit is searched and there is no entry hit as a search result, and the alerting unit notifies the user terminal that it is unclear whether the new function will be successfully installed.

The memory unit of the function managing apparatus does not store combinations of new functions to be installed on the user terminal and previously installed functions. That is, information relating to the status of the user terminal can be said to be new information in the function managing apparatus. In this case, the function managing apparatus notifies the user terminal whether or not it is unclear that there is a possibility that the new function to be installed in the user terminal may generate a fault in the user terminal. Therefore, the user can take precautions when installing the new function in the user terminal.

A fifth aspect of the invention provides, in the second aspect, a function managing apparatus in which that the receiving unit further receives an installation sequence of the functions installed on the user terminal, the memory unit further associates and stores the installation sequence of a plurality of functions, and data indicating whether the last installed function among the plurality of functions was successfully installed in user terminal on which the another functions have been previously installed. Then, the predicting unit reads from the memory unit the data indicating whether the new function was successfully installed in the user terminal on which one or more installed functions have been installed previously.

Even when the same new function is installed in the user terminal where the installed function is the same, a fault may or may not occur depending on the installation sequence of the functions installed on the user terminal. The function managing apparatus predicts whether or not a new function can be installed normally based on the installation sequence of functions that have been previously installed. Therefore, the function managing apparatus can discover whether or not a fault will be generated in the user terminal when a new function is added before the new function is added.

A sixth aspect of the invention provides, in the second aspect, a function managing apparatus further provided with a result collecting unit configured to collect from the user terminal data indicating whether a new functions was successfully installed on the user terminal, and an updating unit configured to update the memory unit based on the results collected by the data collecting unit.

The function managing apparatus can normally store the installation results of the latest new functions.

A seventh aspect of the invention further provides, in the first aspect, a function classifying unit configured to classify and store functions having similar functions, and an alternate searching unit configured to search for another function similar to a new function from the function classifying unit in accordance with the prediction result of the predicting unit. Moreover, a function managing apparatus is provided in which the alerting unit notifies the user terminal of the function identifier specifying the other function searched by the alternate searching unit.

The function managing apparatus transmits an alternative function to the new function to the user terminal when, for example, a new function to be installed on the user terminal is predicted to have the possibility of generating a fault on the user terminal. Therefore, the user is notified of the risk the new function to be installed on the user terminal poses for that user terminal before the new function are installed on the user terminal, and can install an alternative function on the user terminal.

The present invention makes a user aware of a concern that a fault may occur in a terminal before a function, such as new software, hardware and the like, is installed in the terminal, thus avoiding a fault in the user terminal.

### BRIEF DESCRIPTION OF THE DRAWINGS

FIG. 1 is a structural diagram of a terminal security system of a first embodiment;

FIG. 2 is a function structure diagram of a user terminal of a first embodiment;

FIG. 3 is a conceptual illustration of information stored in a memory unit of the user terminal of the first embodiment;

FIG. 4 is an example of a prediction output by a PC in the first embodiment;

FIG. 5 is a function structure diagram of a function managing apparatus of the first embodiment;

FIG. 6 is a result prediction table stored in the memory unit of the function managing apparatus of the first embodiment;

FIG. 7 is a function classification table stored in the memory unit of the function managing apparatus of the first embodiment;

FIG. 8 is an operation flow chart in the terminal security system of the first embodiment;

FIG. 9 is a main routine of the user terminal of the first embodiment;

FIG. 10 is a main routine of the function managing apparatus of the first embodiment;

FIG. 11 is a structural diagram of a terminal security system of a second embodiment;

FIG. 12 is a function structure diagram of the user terminal of the second embodiment;

FIG. 13 is a function structure diagram of a terminal including the function managing apparatus of the second embodiment; and

FIG. 14 is an operation flow chart of the terminal security system of the second embodiment.

### DESCRIPTION OF THE PREFERRED EMBODIMENTS

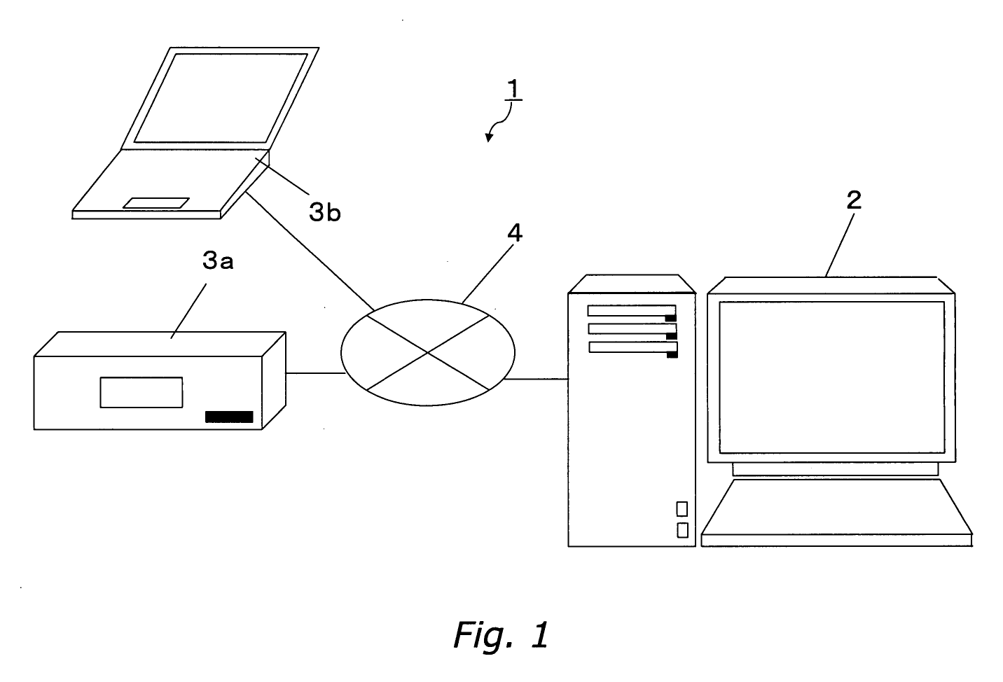

The present invention is described in detail hereinafter using FIGS. 1 through 14.

### First Embodiment

(1) System Structure

FIG. 1 is a structural diagram of the terminal security system using the function managing apparatus of a first embodiment of the present invention. A terminal security system 1 includes a function managing apparatus 2, and user terminals 3a and 3b. The user terminals 3 are, for example, a home server 3a, and PC 3b. When a new function is to be installed on home server 3a, the function managing apparatus 2 predicts the result of the installation of the new function on the home server 3a, and transmits the prediction result to the home server 3a. The home server 3a receives and outputs the prediction result from the function managing apparatus 2 over a network 4 before the new function is installed on the home server terminal. The “prediction result” of the installation of the new function on the home server 3a is information predicting whether or not the new function will install normally on the home server 3a based on the “compatibility” of the new function to be installed, relative to the functions previously installed on the home server 3a.

The user terminals 3 in the present embodiment is not limited to the home server 3a and PC 3b. The user terminal may be a terminal capable of configuring a network with the function managing apparatus 2, and on which new functions can be installed. Although the number of user terminals in the present embodiment is two terminals, the present invention is not limited to this number inasmuch as the present invention is applicable to one or more user terminals.

(2) User Terminal Structure

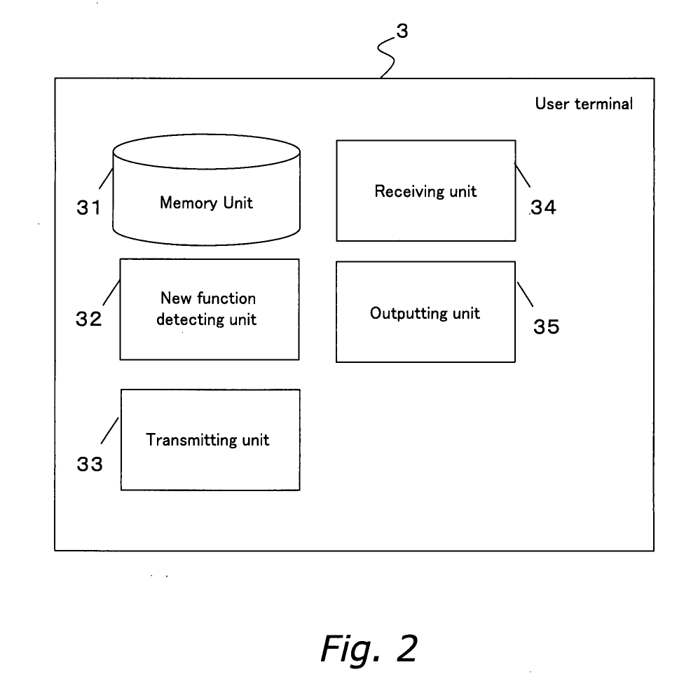

FIG. 2 is a function structure diagram of the user terminal 3 of the first embodiment shown in FIG. 1. The user terminal 3 of FIG. 2 includes a memory unit 31, new function detecting unit 32, transmitting unit 33, receiving unit 34, and outputting unit 35.

(2-1) Memory Unit

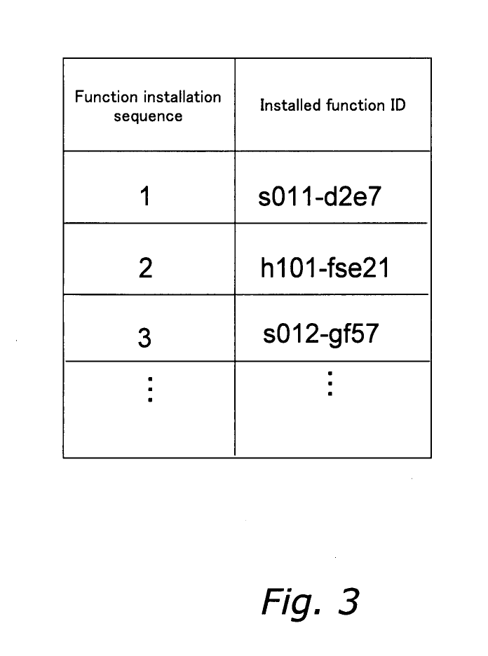

The memory unit 31 stores the function IDs of the installed functions previously installed on the terminal. FIG. 3 is a conceptual illustration of the information stored on the memory unit 31 of the user terminal 3. The memory unit 31 of FIG. 3 stores installation history that includes the installation sequence of installed functions installed on the terminal and the function IDs of the installed functions of the terminal in one record. Specifically, the user terminal 3 has a function with the function ID “s011-d2e7” first in the installation sequence. The function with the function ID “h1015-fse21” is second in the installation sequence. The function with the function ID “s012-gf57” is third in the installation sequence.

The function ID is described below. The function ID includes, for example, identifiers representing the attributes of the function. Specifically, the function ID may include hardware and software product information, the product name, product number and the like. For example, the function IDs shown in FIG. 3 includes an identifier “s” representing software, or an identifier “h” representing hardware, at the top of each ID. The three digits after the identifier “s” representing software may also indicate the attributes of the software, in the case of software. For example, in the first function ID of the installation sequence in FIG. 3, the three digits “011” follow the “s” and this is equivalent to an “editor application.” In the second function ID of the installation sequence, the three digits “101” follow the “h” and this is equivalent to “memory.” In the third function ID of the installation sequence, the three digits “012” follow the “s” and this is equivalent a “paint application.”

The function ID of the installed functions previously installed on the terminal are hereinafter referred to as [installed function ID].

Although the installation sequence of installed functions previously installed are included in the installation history information in FIG. 3, the present invention is not limited to this inclusion inasmuch as the installation history information may also include the installed function ID alone.

(2-2) New function Detecting Unit

The new function detecting unit 32 detects preparations for installing a new function to be installed on a terminal by a user, and reads a function ID identifying the new function. New functions include hardware and software. Hereinafter, the function ID identifying new functions are referred to as [new function ID]. The new function detecting unit 32 may also further detect the software and hardware vender information.

When the new function is software, preparations for installing a new function by the user may be, for example, the user inserting media, such as CD-ROM, DVD-ROM or the like on which the software is recorded, in the terminal. The user may also download the software from another server connected to the network 4 with the terminal. In this case, preparations for installing a new function by the user may include the condition of the software having been downloaded, but not yet installed. Furthermore, preparations for installing a new function by a user when the new function is hardware may include the condition that the hardware is connected to the terminal. Specifically, an example of such a condition may be that the user has inserted an SDRAM in a memory slot of the mother board of the terminal, but the terminal has not yet recognized the SDRAM.

(2-3) Transmitting Unit

The transmitting unit 33 transmits the new function ID read by the new function detecting unit 32, and installation history information stored in the memory unit 31 to the function managing apparatus 2. Furthermore, when the user has installed a new function on the terminal, the transmitting unit 33 transmits to the function managing apparatus 2 an installation result representing whether or not the new function installed normally.

(2-4) Receiving Unit

The receiving unit 34 receives from the function managing apparatus 2 a prediction result when a new function to be installed has been installed on the terminal.

(2-5) Outputting Unit

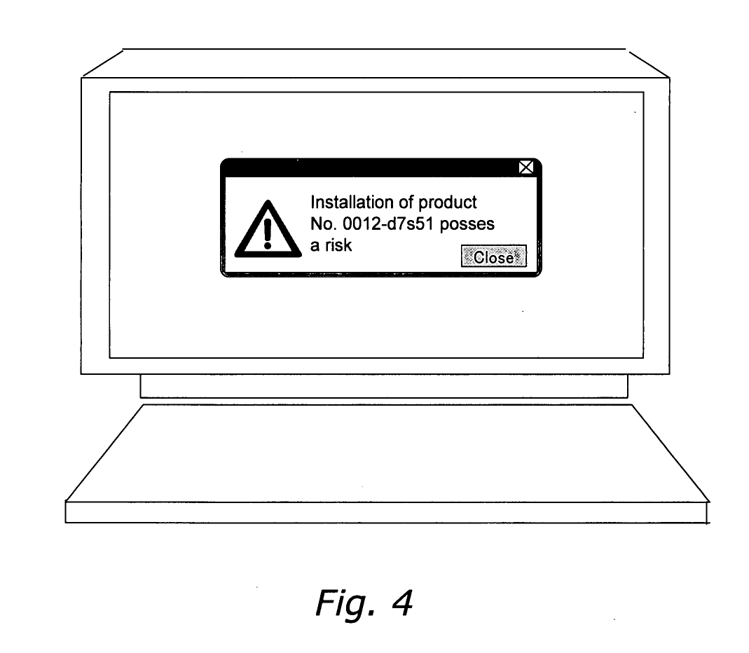

The outputting unit 35 outputs the prediction result received by the receiving unit 34. The output format may, for example, be output as audio, or output for display. FIG. 4 shows an example of a prediction result displayed on a screen. In FIG. 4, the outputting unit 35 outputs a popup message containing the prediction result on a screen. The output format in the present embodiment may also use another display method. In the present embodiment, the outputting unit 35 may also output information received from the function managing apparatus 2 to the user of the terminal. Therefore, the output format is not specifically limited.

(3) Function Managing Apparatus Structure

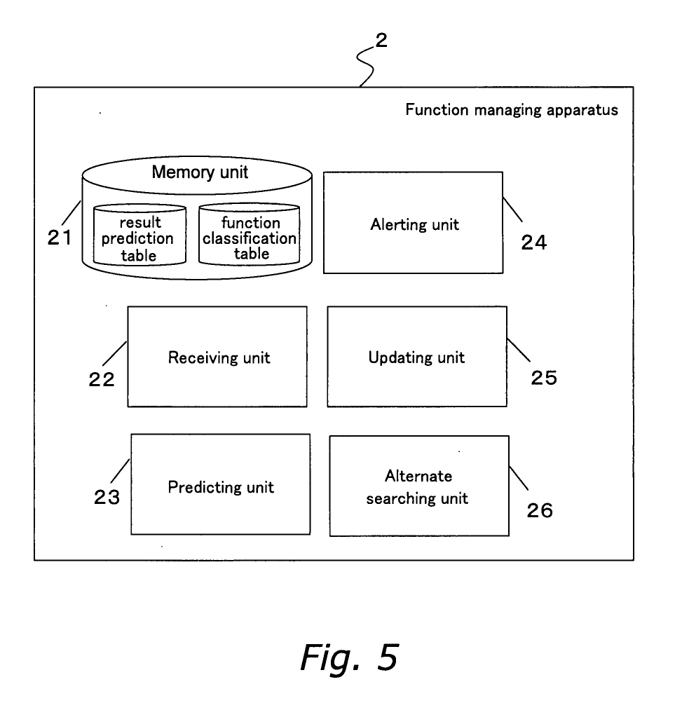

FIG. 5 is a function structure diagram of the function managing apparatus 2 of the first embodiment. The function managing apparatus 2 of FIG. 5 includes a memory unit 21, receiving unit 22, predicting unit 23, alerting unit 24, updating unit 25, and alternate searching unit 26. Each function is described below.

(3-1) Memory Unit

(3-1-1) Result Prediction Table

The memory unit 21 stores a result prediction table that associates combinations of a plurality of function IDs that respectively specify a plurality of functions, and installation results when any function among the plurality of functions was added to the user terminal 3 on which other functions have been installed. The installation results include the successes and failures when any function among the plurality of functions was added to the user terminal 3 on which other functions were previously installed. That is, the installation result is the result representing whether or not one function among the plurality of functions was installed normally on the user terminal 3 on which other functions were previously installed.

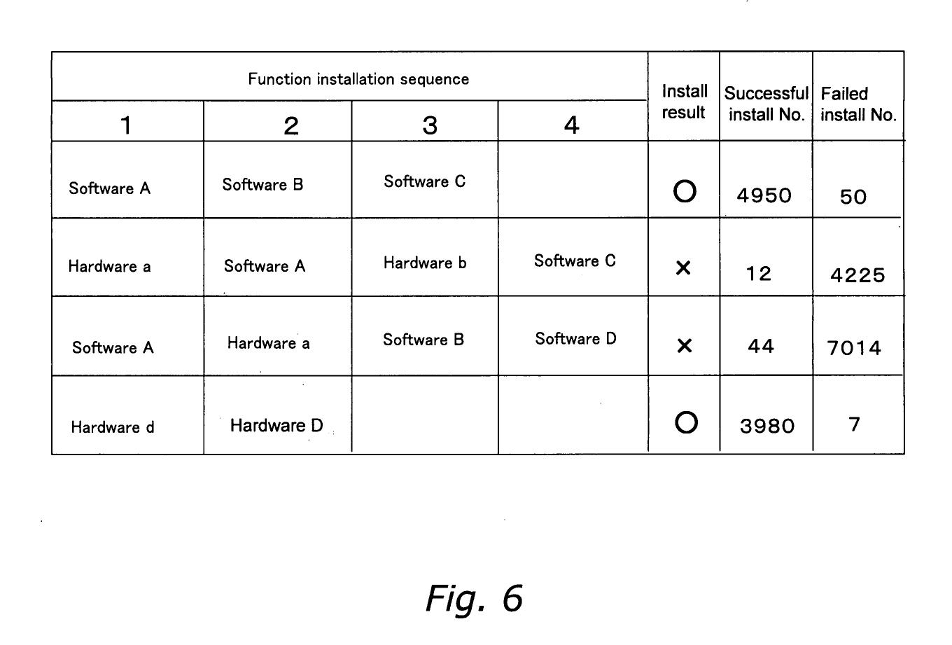

FIG. 6 is a conceptual illustration of a result prediction table. FIG. 6 shows an example when the plurality of function IDs is product names to simplify the description. The DB (database) of FIG. 6 stores the product name, installation result, successful installation number, and failed installation number in the installation sequence in one record. The installation result represents the result when the last function of the installation sequence was added the other previous functions. The installation result of FIG. 6 is “O” the last function of the installation sequence is installed normally, and “X” when installation is not normal. Furthermore, the successful installation number represents the total number of user terminals 3 on which the last function of the installation sequence was normally installed. The failed installation number represents the total number of user terminals 3 on which the last function of the installation sequence did not install normally.

Specifically, the uppermost record in FIG. 6 shows that on the user terminals 3, on which a software A was installed first and a software B was installed second, the software C installed normally. In this record, the successful installation number is “4950,” and the failed installation number is “50.” The next record shows that on the user terminal 3, on which a hardware a was installed first, a software A was installed second, and a hardware b was installed third, the software C did not install normally. That is, a fault occurred. In this record, the successful installation number is “12,” and the failed installation number is “4225.”

Although the memory unit 21 stores the installation sequence and a plurality of function IDs in the present embodiment, the present invention is not limited to this arrangement. The memory unit 21 may also store a plurality of function IDs alone. Furthermore, although the successful installation number and failed installation number are stored in the present embodiment, the invention is not limited to this arrangement. The memory unit 21 also may store information that allows determination of a result as to whether or not the last function in the installation sequence installed normally.

(3-1-2) Function Classification Table

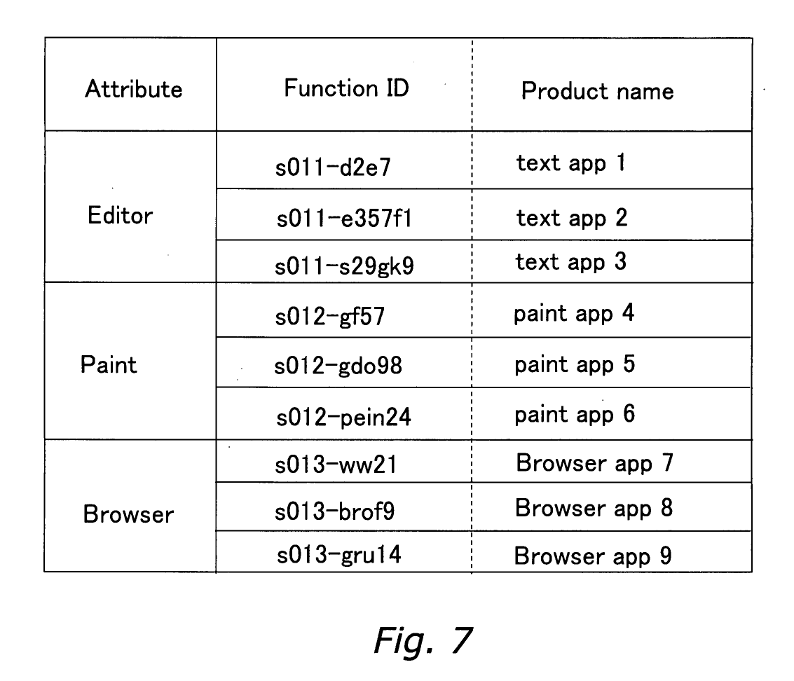

The memory unit 21 further stores a function classification table in which functions are classified with similar functions. For example, when the function ID includes attribute ID representing an attribute of the function, the memory unit 21 classifies and stores the function based on the attribute ID. FIG. 7 is a conceptual illustration of a function classification table. FIG. 7 shows an example when a plurality of functions is software. As shown in FIG. 7, the memory unit 21 stores software in which the attribute IDs of “editor,” “paint,” and “browser” are “s011,” “s012,” “s013.” For example, the product names text applications 1˜3 having the function IDs “s011-d2e7,” “s011-e357f1,” and “s011-s29gk9” are associated and stored in the attribute “editor.” The product names paint applications 4˜6 having the function IDs “s012-gf57,” “s012-gdo98,” and “s012-pein24” are associated and stored in the attribute “paint.” The product names browser applications 7˜9 having the function IDs “s013-ww21,” “s013-brof9,” and “s013-gru14” are associated and stored in the attribute “browser.”

Although the memory unit 21 classifies and stores functions based on the attribute ID, the invention is not limited to this arrangement. The memory unit 21 may also classify and store functions by attribute differentiation using other methods. Furthermore, although the above description pertains to software, the memory unit 21 can also similarly classify and store hardware.

(3-2) Receiving Unit

The receiving unit 22 receives from the user terminal 3 the history information and new function ID identifying the new function to be installed on the user terminal 3.

When a new function is installed on the user terminal 3, the receiving unit 22 receives from the user terminal 3 the result representing whether or not the new function installed normally.

(3-3) Predicting Unit

The predicting unit 23 predicts the result when a new function is installed on the user terminal 3 based on the installation history information and new function ID received from the receiving unit 22. When the memory unit 21 associates and stores the installation result and the combinations of a plurality of function IDs specifying respective pluralities of functions, the predicting unit 23 searches the memory unit 21 using the combinations of the new function ID and the pluralities of installed function IDs, as well as their installation sequences as search keys. The prediction result of the predicting unit 23 is an installation result stored in an entry that is hit in the results searched in the DB of the memory unit 21. That is, the predicting unit 23 searches the content of the result prediction table of the memory unit 21 for records matching the installation sequence and combination of information of the new function ID added to the installed function IDs received from the receiving unit 22. When a match is found, the predicting unit 23 sets the installation result of that record of the memory unit 21 as the prediction result.

Specific examples are provided below. Consider the case of installing a new software C on a user terminal 3 on which a software A and software B have been previously installed. The user terminal 3 has the software A installed first, and the software B installed second. In this case, the receiving unit 22 of the function managing apparatus 2 receives the installation history information that includes the installation sequence and IDs identifying the software A and B. The predicting unit 23 adds the ID identifying the software C to the installation history information that includes the installation sequence and IDs identifying the software A and B, and searches the memory unit 21 for records of the same combination and installation sequence as this information. In FIG. 6, the memory unit 21 stores a record with the installation result “O” when the software A was installed first, software B was installed second, and software C was installed third. Then, the predicting unit 23 extracts the installation result of that record in the result prediction table of the memory unit 21. The predicting unit 23 predicts that the user terminal 3 can install the software C normally based on the installation result “O” and sends the prediction result to the alerting unit 24.

Furthermore, it is admitted that an installation result for when the software A is installed first and software B is installed second beforehand, and the software C is installed thereafter may not be stored in the memory unit 21. This situation is equivalent to the current nonexistence of a user terminal on which the combination and installation sequence of software A, B, C has been installed. Thus, when the predicting unit 23 would find no entries that hit the result searched in the memory unit 21, the predicting unit 23 would determine that the prediction result is unclear, and send this finding to the alerting unit 24.

Thus, the function managing apparatus 2 can discover details of whether or not a fault will occur in the user terminal 3 when a new function is added before the new function is added.

When the alerting unit 24 is notified of a prediction result, the predicting unit 23 may further calculate and transmit the probability of successful installation and probability of failed installation from the number of successful installations and number of failed installations stored on the record in the memory unit 21.

(3-4) Alerting Unit

The alerting unit 24 transmits the prediction result of the predicting unit 23 to the user terminal 3. For example, when the predicting unit 23 predicts that a new function can be installed normally on a user terminal 3 based on an installation result “O”, information indicating that the “new function will install normally” is sent to the user terminal 3 on which the new function is to be installed by the alerting unit 24. When the predicting unit 23 predicts that a fault will occur when a new function is installed on a user terminal 3 based on an installation result “X”, information indicating that the “installation of the new function poses a risk” is sent to the user terminal 3 on which the new function is to be installed by the alerting unit 24. Furthermore, when there is no entry hit in the results of the search in the memory unit 21 and the predicting unit 23 has determined that the prediction result is unclear, the alerting unit 24 sends information indicating that a “corresponding installation result not found” to the user terminal 3 on which the new function is to be installed.

The alerting unit 24 may also notify the user terminal 3 regarding information other than the prediction result. For example, when the alerting unit 24 has received the probability of successful installation and probability of failed installation by the predicting unit 23, the alerting unit 24 may also notify the user terminal 3 regarding these probabilities.

(3-5) Updating Unit

When the receiving unit 22 receives a result indicating whether or not a new function was installed normally from the user terminal 3, the result prediction table of the memory unit 21 is updated based on this installation result by the updating unit 25.

Examples are described below. Consider a case in which a record identical to information of a new function added to the installation history of a user terminal 3 is stored in the result prediction table of the memory unit 21. When the receiving unit 22 has received a result that a new function has been installed normally on the user terminal 3, the updating unit 25 increments the successful installation number of that record stored in the memory unit 21. When the new function cannot be installed normally on the user terminal 3, that is, when the receiving unit 22 has received a result indicating that a fault has been generated on the user terminal 3, the updating unit 25 increments the failed installation number of that record stored in the memory unit 21. The updating unit 25 updates the installation results in the result prediction table of the memory unit 21 based on the incremented successful installation number and failed installation number. For example, the updating unit 25 updates the installation result to “O” when the successful installation number exceeds the failed installation number (successful installation number>failed installation number). The updating unit 25 updates the installation result to “X” when the failed installation number exceeds the successful installation number (failed installation number>successful installation number).

When a new function has been installed on the user terminal 3 and the installation result has not been stored in the memory unit 21, the updating unit 25 records the installation result based on the result transmitted from the user terminal 3. When the receiving unit 22 has received a result that a new function has been installed normally on the user terminal 3, the updating unit 25 records the installation result as “O” in that record of the memory unit 21. When the receiving unit 22 has received a result that a new function has not installed normally on the user terminal 3, the updating unit 25 records the installation result as “X” in that record of the memory unit 21.

Thus, the updating unit 25 updates the result prediction table of the memory unit 21 with new information.

(3-6) Alternate Searching Unit

The alternate searching unit 26 searches for an alternative function of a new function from the memory classification table of the memory unit 21 according to the prediction of the predicting unit 23. That is, when the predicting unit 23 predicts that a fault will be generated when a new function is installed on the user terminal 3, the alternate searching unit 26 searches for another function having the same attributes as the new function from the function classification table of the memory unit 21.

For example, the text application 1 is a function to be installed on the user terminal 3, and the predicting unit 23 predicts that a fault will be generated when the “text application 1” is installed on the user terminal 3. In this case, the alternate searching unit 26 searches the function classification table of the memory unit 21 for a function other than the “text application 1,” that is, an “editor,” that has the same attributes as the “text application 1.” The memory unit 21 stores the function classification table as shown in FIG. 7. In this case, the alternate searching unit 26 selects either “text application 2” or “text application 3” that are other functions than the “text application 1.” When, for example, the alternate searching unit 26 selects “text application 2,” the function ID “s011-e357f1” identifying the “text application 2” is sent to the predicting unit 23. The predicting unit 23 then predicts whether or not the “text application 2” indicated by the function ID “s011-e357f1” will install normally on the user terminal 3. When the predicting unit 23 determines that the “text application 2 will install normally on user terminal 3,” the alerting unit 24 sends the function ID “s011-e357f1” of the “text application 2” to the user terminal 3.

When the predicting unit 23 predicts “text application 2 will not install normally on user terminal 3,” the alternate searching unit 26 searches the function classification table of the memory unit 21 for an application other than the “text application 1” and “text application 2,” that is, an “editor,” that has the same attributes as the “text application 1.” When the predicting unit 23 selects the “text application 3,” the function ID “s011-s29gk9” identifying the “text application 3” is sent to the predicting unit 23.

When the result of the search of the memory unit 21 by the alternate searching unit 26 determines that there is no other alternative function to the new function, the determination result is sent to the alerting unit 24.

Although software has been used in the above description, the alternate searching unit 26 searches and selects hardware in the same manner.

(4) Sequence of Operation Flow

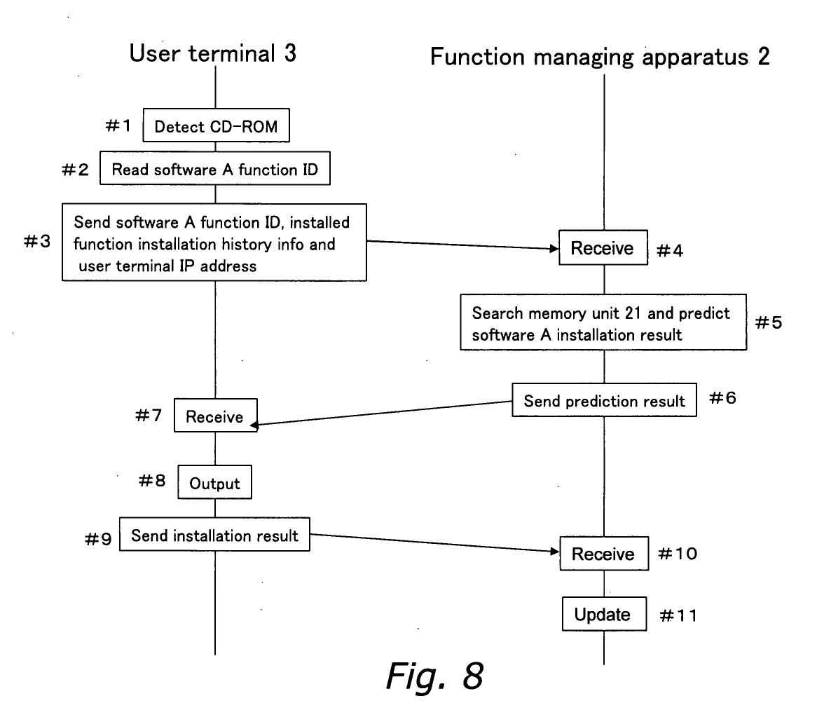

The operation sequence of the terminal security system 1 using the user terminals 3 and the function managing apparatus 2 of the first embodiment of the present invention is described below. FIG. 8 is an operation flow chart of the terminal security system 1 using the user terminals 3 and the function managing apparatus 2 of the first embodiment. A case in which the user of a user terminal 3 intends to install the software A is described in an example below to facilitate the description. First, the user inserts a CD-ROM on which the software A is recorded in to the CD-ROM drive of the user terminal 3.

The new function detecting unit 32 of the user terminal 3 detects the insertion of the CD-ROM into the CD-ROM drive (#1), and reads the function ID identifying the software A from the CD-ROM (#2). Then, the transmitting unit 33 of the user terminal 3 sends the function ID of the software A read by the new function detecting unit 32, the installation history information of function previously installed on the user terminal 3, and the IP address of the user terminal 3 to the function managing apparatus 2 (#3). The installation history information includes the installed function IDs and installation sequence of the software and hardware previously installed on the user terminal 3.

The receiving unit 22 of the function managing apparatus 2 receives the function ID identifying the software A, installation history information of the user terminal 3, and IP address (#4). The predicting unit 23 of the function managing apparatus 2 searches the result prediction table of the memory unit 21 using the information with the added function ID identifying the software A in the installation history information of the user terminal 3 as a search key. Then, the predicting unit 23 predicts whether or not the software A will install normally on the PC 3 based on the search result (#5).

The alerting unit 24 of the function managing apparatus 2 sends a prediction result when the software A is installed on the user terminal 3 to the IP address destination of the user terminal 3 (#6). The receiving unit 34 of the user terminal 3 receives the prediction result (#7), and the outputting unit 35 outputs the prediction result (#8).

When the software A has been installed on the user terminal 3 after the prediction result has been output from the function managing apparatus 2, the transmitting unit 33 of the user terminal 3 sends the status of the terminal itself after the installation of the software A to the function managing apparatus 2 (#9). That is, the transmitting unit 33 of the user terminal 3 sends to the function managing apparatus 2 information as to whether the software A installed normally, or a fault was generated in the terminal by the installation of the software A (#10).

The updating unit 25 of the function managing apparatus 2 updates the result prediction table of the memory unit 21 based on the received result (#11).

Although the transmitting unit 33 of the user terminal 3 sends the installation history information to the function managing apparatus 2 in the above operation flow, the present invention is not limited to this arrangement. The transmitting unit 33 of the user terminal 3 also may send only the installation function IDs of the hardware and software previously installed on the user terminal 3.

Although the instance of installing software on the user terminal 3 is described in the operation flow above, this operation flow is also applicable to hardware.

Although the instance of recording software on a CD-ROM is described in the operation flow above, the present invention is not limited to this instance. A user may also download software from the Web.

(5) User Terminal Main Routine

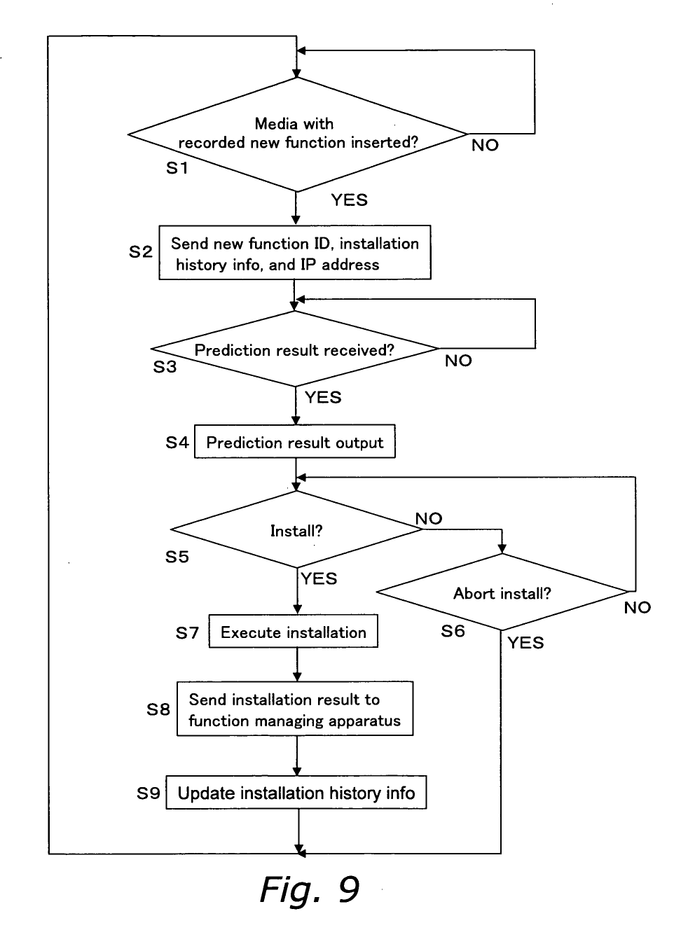

The main routine of the user terminal 3 is described below. FIG. 9 shows the main routine of the user terminal 3. The example of a user intending to install software A on a user terminal 3 is described below identical to the situation in section (4) Sequence of Operation Flow. First, a user inserts media such as a CD-ROM or the like on which the software A is recorded into the CD-ROM drive of the user terminal 3.

Step S1: The new function detecting unit 32 is on standby until the media on which the new function to be installed by the user is recorded is inserted into the terminal. The new function detecting unit 32 reads the new function ID from the media when the insertion of the media on which the new function is recorded is detected.

Step S2: The transmitting unit 33 fetches the installation history information of the user terminal from the memory unit 31. The transmitting unit 33 sends the new function ID read by the new function detecting unit 32, the installation history information fetched from the memory unit 31, and the IP address of the terminal itself to the function managing apparatus 2.

Step S3: The receiving unit 34 is on standby until the prediction result indicating whether or not the new function will install normally on the terminal itself is received from the function managing apparatus 2.

Step S4: In step S3, the outputting unit 35 outputs the prediction result when the receiving unit 34 has received the prediction result from the function managing apparatus 2.

Steps S5 and S6: The new function detecting unit 32 detects the operation of the user preparing to install the new function on the user terminal.

Steps S7 and S8: When the user has installed the new function on the user terminal, the transmitting unit 33 sends the status of the terminal after the installation of the new function to the function managing apparatus 2. That is, the transmitting unit 33 sends the result indicating whether or not the new function installed normally to the function managing apparatus 2.

Step S9: An updating unit (not shown in the drawing) adds the new function ID identifying the new function to be installed on the terminal to the end of the history sequence of the installation history information stored in the memory unit 31.

Although the instance of installing software on the user terminal is described in the operation flow above, this operation flow is also applicable to hardware.

Although the instance of recording software on a CD-ROM is described in the operation flow above, the present invention is not limited to this instance. A user may also download software from the Web.

(6) Function Managing Apparatus Main Routine

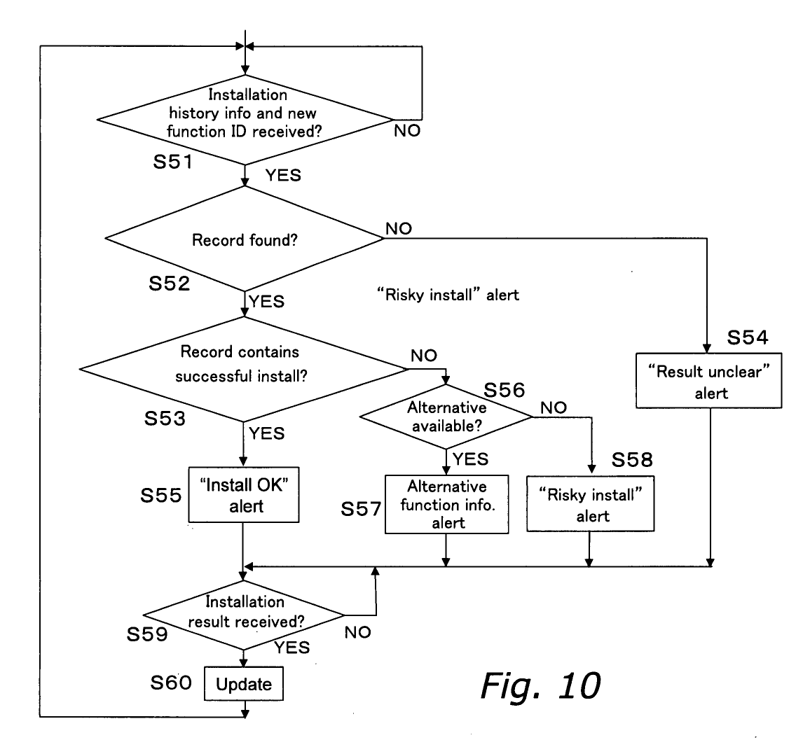

The main routine of the function managing apparatus 2 is described below. FIG. 10 shows the main routine of the function managing apparatus 2.

Step S51: The receiving unit 22 is on standby until the new function ID identifying the new function to be installed on the user terminal 3, the installation history information discriminating the previously installed functions, and the IP address destination are received.

Step S52: When the receiving unit 22 receives the new function ID, installation history information, and IP address in step S51, the predicting unit 23 searches the result prediction table of the memory 21 using information with the new function added to the installation history information as a search key. That is, the predicting unit 23 searches whether or not there is a record matching the information with the new function ID added to the installation history information among the records in the result prediction table of the memory unit 21.

Step S53: When a record is found that matches the information with the new function ID added to the installation history information in the result prediction table of the memory unit 21 in step S52, the predicting unit 23 extracts the installation result of that record in the result prediction table of the memory unit 21.

Step S54: When the search result is that no record is found that matches the information with the new function ID added to the installation history information in the DB of the memory unit 21 in step S52, the predicting unit 23 determines that the prediction is unclear. The alerting unit 24 sends the result indicating that the “prediction is unclear” to the received IP address destination.

Step S55: When the extracted installation result is O in step S53, the predicting unit 23 predicts the new function will install normally. The alerting unit 24 sends the information indicating that the “new function will install normally” to the received IP address destination.

Step S56: When the extracted installation result is X in step S53, the alternate searching unit 26 searches for a function similar to the new function from the function classification table of the memory unit 21. Then, the alternate searching unit 26 extracts the ID identifying the similar function and sends the ID to the predicting unit 23. The predicting unit 23 predicts whether or not the similar function can be installed normally on the user terminal 3.

Step S57: When the predicting unit 23 has determines that the similar function can be installed normally in step S56, the alerting unit 24 sends the function ID identifying the similar function to the received IP address destination.

Step S58: When there is no other function similar to the new function in the function classification table in the memory unit 21, and when the predicting unit 23 has predicted that the similar function will not install normally on the user terminal 3 in step S56, the alerting unit 24 sends information indicating that “installation of the new function poses a risk” to the received IP address destination.

Step S59: The receiving unit 22 receives the installation result indicated whether or not the new function installed normally on the user terminal 3.

Step S60: The updating unit 25 updates the result prediction table based on the received installation result in step S59.

Although the instance of installing software on the user terminal is described in the operation flow above, this operation flow is also applicable to hardware.

(7) Effects

The function managing apparatus 2 predicts whether or not a new function will install normally on a user terminal 3 before the new function, such as software and hardware and the like is installed. The user terminal 3 receives and outputs the result as to whether or not a fault will be generated by installing the new function to be installed on the terminal before the new function is installed. Therefore, when, for example, there is concern that a fault might be generated in the user terminal 3 as a result of installing a new function on the user terminal 3, the user is made aware of that concern before the new function is installed, and can take measures such as terminating the installation, and installing another alternative function and the like.

Although the user is notified of another alternative function similar to the new function when the predicting unit 23 of the function managing apparatus 2 has predicted that a new function can not be installed normally on a user terminal 3 in the examples above, the present invention is not limited to this arrangement. The function managing apparatus 2 also may send only the prediction result of the predicting unit 23 to the user terminal 3.

### Other Embodiments

(1) System Structure

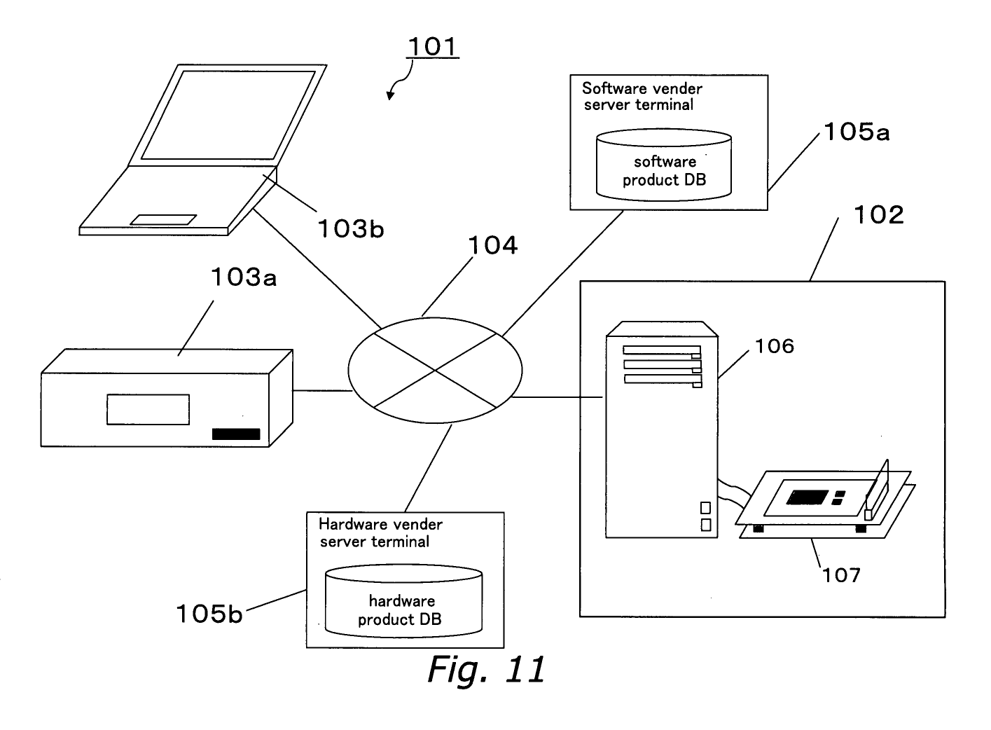

FIG. 11 is a structural diagram of a terminal security system 101 of a second embodiment of the present invention. The terminal security system 101 of the second embodiment is provided with a software vender server terminal 105a and hardware vender server terminal 105b in addition to the first embodiment, and these server terminals are connected to a network 104. The software and hardware vender terminals 105 respectively have a software and hardware product DB. The software product DB associates and stores the install data and the function IDs identifying the software manufactured by a vender. The hardware product DB associates and stores the circuit information and function IDs identifying the hardware manufactured by a vender.

The vender server terminal 105 is described below. For example, the server terminal 105a for a vender that manufactures software A has received a function ID identifying the software A and the IP address of a user terminal 103 from the user terminal 103 on which the software A is intended to be installed. The software A vender server terminal 105a extracts software A installation data from the software product DB on the server terminal based on the function ID identifying the software A. Then, the software A vender server terminal 105a sends the software installation data and IP address of the user terminal 103 to the function managing apparatus 102.

The server terminal 105b for a vender that manufactures a memory B has received a function ID identifying the memory B and the IP address of a user terminal 103 from a user terminal 103 on which the memory B is intended to be installed. The memory B vender server terminal 105b extracts circuit information of the memory B from the hardware product DB on the server terminal based on the function ID identifying the memory B. Then, the memory B vender server terminal 105b sends the circuit information of the memory B and IP address of the user terminal 103 to the function managing apparatus 102.

In other aspects the structure of the terminal security system 101 of the second embodiment is identical to the terminal security system 1 of the first embodiment. That is, a function managing apparatus 102 and user terminals 103 are included. The user terminal 103 may be, for example, a home server 103a, and PC 103b. When a new function is to be installed on the home server 103a, the function managing apparatus 102 predicts the result when the new function has been installed on the home server 103a, and sends this prediction result to the home server 103a. The home server 103a receives and outputs the prediction result from the function managing apparatus 102 over the network 104 before the new function is installed on the home server. “Prediction result” is information predicting whether or not the new function can install normally on the home server 103a based on the “compatibility” of the new function to be installed and the functions previously installed on the home server 103a.

The user terminal 103 of the present embodiment is not limited to the home server 103a and PC 103b. The user terminal 103 of the present embodiment may be a terminal capable of configuring a network 104 with the function managing apparatus 102, and on which new functions can be installed. Although the number of user terminals in the present embodiment is two terminals, the present invention is not limited to this number inasmuch as the present invention is applicable to one or more user terminals.

(2) User Terminal Structure

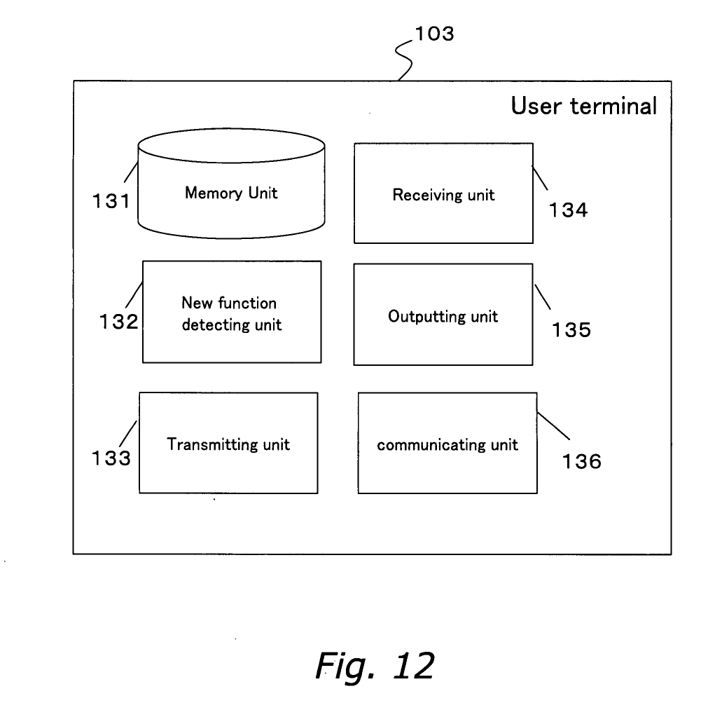

FIG. 12 is a function structure diagram of the user terminal 103 of the second embodiment. The user terminal 103 of FIG. 12 includes a communication unit 136 in the user terminal 3 of the first embodiment. That is, the user terminal 103 of the present embodiment includes a memory unit 131, new function detecting unit 132, transmitting unit 133, receiving unit 134, outputting unit 135, and communicating unit 136.

The memory unit 131 stores all data, such as applications and the like, installed on the user terminal. All data are, for example, spreadsheet applications, document preparation applications and the like, and all applications installed on the user terminal itself. All data includes one or more function IDs identifying functions previously installed on the user terminal. The function ID includes the software and hardware product information identical to the first embodiment, for example, product information, product number, and product name and the like. In other respects the function ID is identical to that of the first embodiment, and further description is omitted. The memory unit 131 may also store installation history information that includes the installed function ID and function installation sequence of the previously installed functions.

The new function detecting unit 132 detects preparations for installing a new function to be installed on a terminal by a user, and reads a function ID identifying the new function, and vender information. The vender information is information indicating the manufacturer of the new function the user intends to install on the user terminal.

The transmitting unit 133 sends all data stored in the memory unit 131, and the user terminal IP address to the function managing apparatus 102. That is, the transmitting unit 133 sends all data of the user terminal in order for the function managing apparatus 102 to recognize the status of the user terminal 103 and predict whether or not the new function can be installed normally.

The receiving unit 134 receives from the function managing apparatus 102 the prediction result describing the result of installing the new function to be installed on the user terminal.

The outputting unit 135 outputs the prediction result received by the receiving unit 134. The output format may, for example, be output as audio, or output for display. In the present embodiment, similar to the first embodiment, the outputting unit 135 also may output information received from the function managing apparatus 102 to the user of the user terminal. Accordingly, the output is not specifically limited.

The communicating unit 136 accesses the server terminal 105 of each vender based on the vender information detected by the new function detecting unit 132, and performs communication based on the new function ID. For example, consider a case in which the software A recorded on a CD-ROM is to be installed on the user terminal 103. The communicating unit 136 accesses the server terminal 105a of the vender of the software A based on the vender information detected by the new function detecting unit 132, and sends the ID identifying the software A, and the IP address of the user terminal. When the memory B is to be installed on the user terminal 103, the communicating unit 136 accesses the server terminal 105b of the vender of the memory B based on the vender information detected by the new function detecting unit 132, and sends the ID identifying the memory B, and the IP address of the user terminal.

(3) Function Managing Apparatus Structure

The function managing apparatus 102 of the second embodiment of the present invention includes a terminal 106, and basic function board 107. The function managing apparatus 102 of the present embodiment predicts whether or not the new function can be installed normally on the user terminal 103 by simulation.

(3-1) Terminal

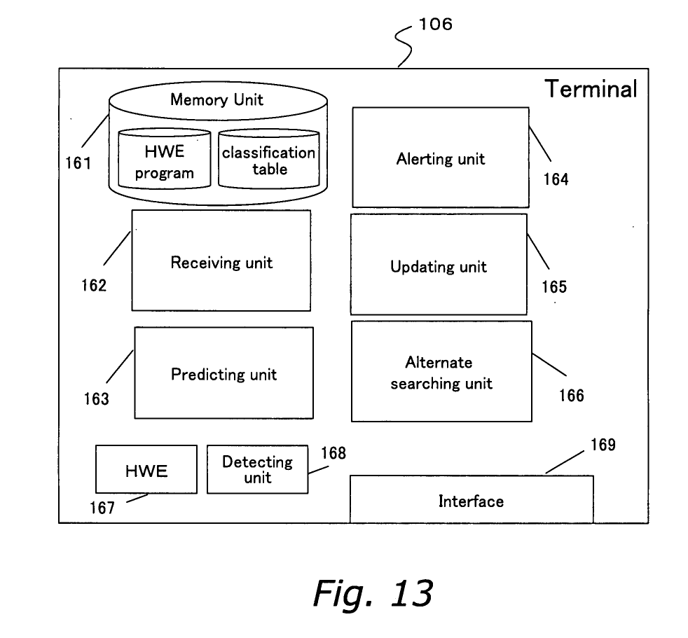

FIG. 13 is a function structure diagram of the terminal 106 of the second embodiment of the present invention. The terminal 106 of FIG. 13 includes a memory unit 161, receiving unit 162, predicting unit 163, detecting unit 164, updating unit 165, alternate searching unit 166, hardware emulator (hereinafter referred to as “HWE”) 167, detecting unit 168, and interface 169.

The memory unit 161 stores the emulation program of HWE 167. The memory unit 161 further stores a function classification table that classifies functions with similar functions, similar to FIG. 7 of the first embodiment. When the function ID has a discriminator indicating attributes, the memory unit 161 stores functions based on the function ID. Furthermore, when the function ID does not include a discriminator indicating attributes, the memory unit 161 may also classify and store functions by attribute differentials based on the circuit information of hardware and installation data of software received from the server terminal 105 of each vender. For example, when the circuit information of hardware and installation data of software includes a discriminator indicating the attribute of the function, the function is classified and stored on the memory unit 161 based on the discriminator.

The receiving unit 162 receives from the user terminal 103 all data including the function ID identifying the new function to be installed on the user terminal 103, and the installed function IDs of the functions previously installed on the user terminal 103. All data of the user terminal 103 is sent to the basic function board 107 through the interface 169. The receiving unit 162 receives from the server terminal 105 of each vender various data, such as installation data and circuit information and the like of the new function to be installed on the user terminal 103. For example, when the new function is software, the receiving unit 162 receives the software installation data from the software vender server terminal 105a. When the new function is hardware, the receiving unit 162 receives the hardware circuit information from the hardware vender terminal 105b.

The predicting unit 163 predicts the result when the new function is installed on the user terminal 103 based on the data relating to the new function and all data including the installed function IDs received by the receiving unit 162. For example, the basic function board 107 performs a simulation based on the all data of the user terminal 103, and the data of the new function. When a signal indicating the operation of the basic function board 107 is detected by the detecting unit 168, the predicting unit 163 predicts whether or no the new function can be installed normally on the user terminal 103 based on this signal. When the detecting unit 168 has detected a signal indicating normal operation of the basic function board 107, the predicting unit 163 predicts that the “new function can install normally on user terminal 103.” When the detecting unit 168 has detected a signal indicating abnormal operation of the basic function board 107, the predicting unit 168 predicts that the “new function can not install normally on user terminal 103.”

The alerting unit 164 sends the prediction result of the predicting unit 163 to the user terminal 103.

The updating unit 165 updates the function classification table stored in the memory unit 161. For example, when the receiving unit 162 has received data of a new function to be installed on the user terminal 103 from the vender server terminal 105, the updating unit 165 extracts the ID that includes the discriminator indicating the attribute of the function from the data of the new function. The updating unit 165 writes the function ID in that attribute in the function classification table based on the extracted discriminator.

The alternate searching unit 166 search the memory unit 161 for an alternative function to the new function according to the prediction result of the predicting unit 163. That is, when the predicting unit 163 has predicted that “a fault will occur when the new function is installed on the user terminal 103,” the alternate searching unit 166 searches for a different function having the same attributes as the new function from the function classification table of the memory unit 161. When a function similar to the new function is found in the search result, the alternate searching unit 166 extracts the function ID of the hit function and sends the function ID to the predicting unit 163. The predicting unit 163 predicts whether or not the function similar to the new function is an alternative possibility based on the function ID received from the alternate searching unit 166. When the predicting unit 163 has determined that the alternative is possible, the alerting unit 164 sends the function ID determined as a possible alternate to the user terminal 103.

When the new function to be installed on the user terminal 103 is hardware, the HWE 167 hypothetically configures the hardware based on the circuit information of the hardware to be installed. For example, consider a case in which the memory B is to be installed on the user terminal 103. First, the HWE 167 reads the HWE program from the memory unit 161. Then, the HWE 167 emulates the memory B based on the circuit information of the memory B received from the server terminal 105b of the vender of the memory B. When the basic function board 107 is a board provided with the basic functions of the user terminal 103, the hypothetically configured memory B and the basic function board 107 are equivalent to the user terminal 103. Therefore, the predicting unit 163 can predict whether or not the memory B can be installed normally on the user terminal 103.

The detecting unit 168 detects a signal that indicates the operation of the basic function board 107. That is, the detecting unit 168 monitors the operation within the CPU of the basic function board 107. The signal indicating the operation of the basic function board 107 is sent from the basic function board 107 to the terminal 106 through the interface 169. The detecting unit 168 detects this signal. For example, consider a case in which the memory B is to be installed on the user terminal 103. The basic function board 107 is a board identical to the board within the user terminal 103, and all data of the user terminal 103 is stored on the basic function board 107. The detecting unit 168 monitors the operation of the CPU on the basic function board 107 with the added data of the hypothetically configured memory B. That is, the detecting unit 168 detects the signal indicating the operation of the CPU on the basic function board 107 from the basic function board 107 that reproduces conditions identical to a memory B installed on the user terminal 103. Normally, the CPU has a built in circuit that indicates an abnormality when an error is generated in the basic function of the body in which the CPU is installed. The signal indicating the operation of the CPU is output from this circuit. That is, the detecting unit 168 can detect whether or not a fault has been generated in the basic function board 107 by hypothetically configured memory B by detecting the signal indicating the operation of the CPU on the basic function board 107. The detecting unit 168 sends the detected signal to the predicting unit 163.

(3-2) Basic Function Board

The basic function board 107 is connected to the terminal 106 through the interface 169. The basic function board 107 receives from the terminal 106 the data of the hardware hypothetically configured by the HWE 167, and all data of the user terminal 103 received from the terminal 106. The basic function board 107 sends a signal indicating the operation of the CPU on the basic function board 107 and the like to the terminal 106. The basic function board 107 includes the basic hardware functions of the user terminal 103, and is used to reproduce the conditions of the user terminal 103 prior to the installation of a new function. The basic function board 107 includes, for example, the CPU, motherboard, HDD and the like of the user terminal 103. The HDD stores all data of the user terminal 103. That is, the basic function board 107 performs the role of artificially configuring a user terminal 103 on which the new function is to be installed.

The basic function board 107 may also have the condition of when the user terminal 103 was shipped, that is, the condition before other functions were added. Furthermore, when adding an additional new function to a user terminal 103 on which any number of hardware have previously been installed, a plurality of previously installed functions also may be hypothetically configured by the HWE 167. The predicting unit 163 can predict the result when a new function is installed using the basic function board 107 and the hypothetically configured multifunction data.

(4) Operation Flow Sequence

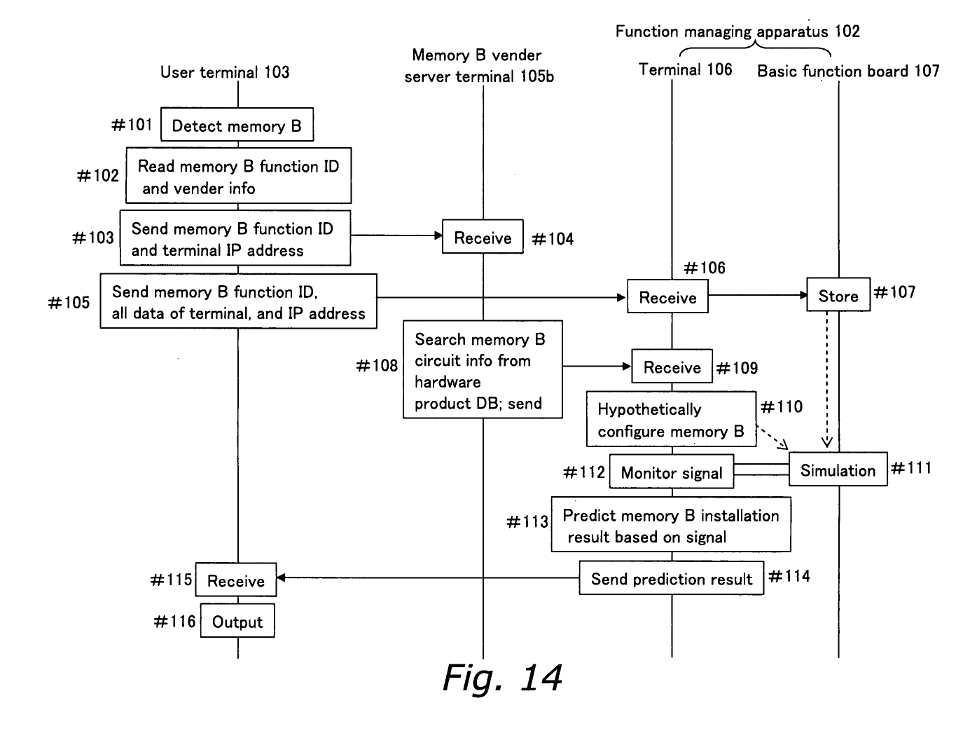

FIG. 14 is an operation flow chart of the terminal security system 101 of the second embodiment. A case in which a user inserts a memory B into a slot on a board in the user terminal 103 described in an example below to facilitate the description.

The new function detecting unit 132 of the user terminal 103 detects the insertion of the memory B into the internal board (#101), and reads the vender information and function ID identifying the memory B from the memory B (#102). The communicating unit 136 of the user terminal 103 accesses the server terminal 105b of the vender of the memory B based on the vender information read from the new function detecting unit 132, and sends the function ID of the memory B and the IP address of the terminal (#103). The server terminal 105b of the vender of the memory B receives the information (#104).

The transmitting unit 133 of the user terminal 103 sends the function ID identifying the memory B, all data of the function to be installed on the terminal, and the IP address to the function managing apparatus 102 (#105). The receiving unit 162 of the terminal 106 in the function managing apparatus 102 receives the information (#106). All data are stored in the HDD of the basic function board 107 (#107). All data of the function being installed on the terminal includes the installation history information of functions previously installed on the user terminal 103.

The server terminal 105b of the vender of the memory B, which has received the function ID identifying the memory B and the IP address from the user terminal 103, searches for and extracts the circuit information of the memory B from the hardware product DB based on the function ID identifying the memory B. Then, the server terminal 105b of the vender of the memory B sends the extracted circuit information of the memory B and the IP address of the user terminal 103 to the function managing apparatus 102 (#108). The receiving unit 162 of the terminal 106 receives this information (#109). The function managing apparatus 102 can determine which user terminal data uses the circuit information of the memory B by sending both the circuit information of the memory B and the IP address of the home server.

Next, the HWE 167 of the terminal 106 reads the HWE program from the memory unit 161, and hypothetically configures a memory B based on the circuit information of the memory B received by the receiving unit 162 (#110). The data of the hypothetically configured memory B are provided to the basic function board 107 through the interface 169.

The basic function board 107 verifies the operation based on the data of the memory B hypothetically configured by the HWE 167, and all data of the user terminal 103 stored in the HDD (#111). The detecting unit 168 of the terminal 106 monitors the signals indicating the operation of the CPU of the basic function board 107 (#112).

Then, when the detecting unit 168 detects the signal indicating the operation of the basic function board 107, the predicting unit 163 of the terminal 106 predicts whether or not the memory B can be installed normally on the user terminal 103 (#113). The communicating unit 164 sends the prediction result to the user terminal 103 (#114). When the detecting unit 168 detects a signal indicating the generation of an error in the CPU on the basic function board 107, the predicting unit 163 predicts that the “memory B can not be installed normally on the user terminal 103.” This time, the alternate searching unit 166 may also search for a memory C as an alternative to the memory B from the function classification table of the memory unit 161, and extract the function ID identifying the memory C. In this case, the alternate searching unit 166 sends the extracted function ID identifying the memory C to the predicting unit 163. When the predicting unit 163 has predicted that the memory C can be installed normally on the user terminal 103, the alerting unit 164 sends the function ID identifying the memory C to the user terminal 103.

The receiving unit 134 of the user terminal 103 receives the prediction result (#115), and the outputting unit 135 outputs the result (#116). When the receiving unit 134 has received the function ID identifying the memory C, the outputting unit 135 may also output the function ID identifying the memory C in addition to the prediction result of the memory B.

Although the above example has been described in terms of installing new hardware as a new function on a user terminal 103, the present embodiment is also applicable to the new installation of software as a new function.

(5) Effects

The function managing apparatus 102 of the present embodiment configures the condition when a new function is installed on the user terminal 103 using the HWE 167 and the basic function board 107, and predicts whether or not the new function to be installed on the user terminal 103 can be installed normally on the user terminal 103. That is, the function managing apparatus 102 determines whether or not the software and hardware to be installed can be installed normally on the user terminal 103 by a simulation. Accordingly, the user of the user terminal 103 is made aware of the possibility that the new function to be installed on the user terminal 103 may generate a fault on the user terminal 103 before the new function is installed. Therefore, even when a fault may be generated in the user terminal 103, the user can avoid producing this fault before installing the new function.

Although the function managing apparatus 102 verifies whether or not a new function to be installed on a user terminal 103 can be installed normally by obtaining information related to the new function through the server terminal 105 of the vender of the software and hardware in the present embodiment, the present invention is not limited to this arrangement. For example, the software and hardware product DB of the vender server terminal 105 also may be provided with a function managing apparatus.

The present embodiment may also use the following methods. For example, the function managing apparatus 102 may include a software emulator and a hardware emulator. That is, the function managing apparatus 102 also may hypothetically configure software and hardware by emulation based on a new function ID and the installation history information of the user terminal 103, and predict whether or not the new function can be installed normally on the user terminal 103.

### INDUSTRIAL APPLICABILITY

The present invention is applicable to terminals to which new functions can be added and which configure a network, such as a home server, PC, portable terminal and the like. Therefore, when a new function is to be installed on the terminal, the terminal can predict whether or not the new function can be installed normally on the terminal itself. Thus, the user of the terminal can avoid generating a fault on the terminal before it occurs.

What is claimed is:

1. A function managing apparatus for communicating with a user terminal, comprising:
a receiving unit configured to receive from the user terminal a new function identifier that identifies a new function to be installed on the user terminal, and installed function identifiers that respectively identify one or more functions previously installed on the user terminal;
a predicting unit configured to specify the new function and the one or more installed functions based on the new function identifier and the installed function identifiers received by the receiving unit, and predict whether the new function will be successfully installed on the user terminal; and
an alerting unit configured to notify the user terminal of the prediction made by the predicting unit.

2. The function managing apparatus according to claim 1, further comprising:
a memory unit configured to associate and store combinations of a plurality of function identifiers that specify a plurality of functions, and data indicating whether or not any function among the plurality of functions has been successfully installed a user terminal on which another function has been previously installed; wherein
the predicting unit is configured to search the memory unit using combinations of one or more installed function identifiers and new function identifiers as search keys, and predict whether the new function will be successfully installed based on the search result.

3. The function managing apparatus according to claim 2, wherein
the memory unit is configured to store, as a prediction result, data indicating whether or not any function among the plurality of functions will be successfully installed in a user terminal on which another function has been previously installed; and
the predicting unit is configured to set, as a prediction result, data indicating whether a function will be successfully installed that is stored in an entry hit as a result of the search.

4. The function managing apparatus according to claim 2, wherein
the predicting unit is configured to determine that the prediction result is unclear when no entry is hit as a result of the search of the memory unit; and
the alerting unit is configured to notify the user terminal that it is unclear whether the new function will be successfully installed.

5. The function managing apparatus according to claim 2, wherein
the receiving unit is configured to receive the installation sequence of the functions installed on the user terminal;
the memory unit is configured to associate and store the installation sequence of the plurality of functions, and data indicating whether the function last installed among the plurality of functions was successfully installed in a user terminal on which another function was previously installed; and
the predicting unit is configured to read from the memory unit the data indicating whether the new function was successfully installed in the user terminal on which one or more installed functions were previously installed.

6. The function managing apparatus according to claim 2, further comprising:
a result collecting unit configured to collect data indicating whether a new function was successfully installed on the user terminal from the user terminal; and
an updating unit configured to update the memory unit based on the data collected by the result collecting unit.

7. The function managing apparatus according to claim 1, further comprising:
a function classifying unit configured to classify and store functions having similar functions;
an alternate searching unit configured to search the function classification unit for another function similar to the new function in accordance with the prediction result of the predicting unit; wherein
the alerting unit is configured to notify the user terminal of the function identifier identifying the other function found by the alternate searching unit.
